(19) United States
(12) Patent Application Publication
(10) Pub. No.: US 2025/0131517 A1
(43) Pub. Date: Apr. 24, 2025

(54) MEAL SUGGESTION DEVICE, MEAL SUGGESTION METHOD, AND RECORDING MEDIUM

(71) Applicant: NEC Corporation, Tokyo (JP)

(72) Inventors: Chie NAKAZONO, Tokyo (JP); Atsuya OBANA, Tokyo (JP); Ryo ISOMURA, Tokyo (JP)

(73) Assignee: NEC Corporation, Tokyo (JP)

(21) Appl. No.: 18/899,491

(22) Filed: Sep. 27, 2024

(30) Foreign Application Priority Data
Oct. 20, 2023 (JP) 2023-180962

(51) Int. Cl. G06Q 50/12; G06Q 10/047

(52) U.S. Cl. CPC G06Q 50/12; G06Q 10/047

(57) ABSTRACT

A meal suggestion device includes at least one memory configured to store instructions; and at least one processor configured to execute the instructions to: acquire target person related data related to a target person to whom a meal is to be suggested; determine a suggested meal to be suggested to the target person using the target person related data; generate basis information indicating a basis for suggesting the suggested meal; and present the suggested meal and the basis information.

This application is based upon and claims the benefit of priority from Japanese Patent Application No. 2023-180962, filed on Oct. 20, 2023, the disclosure of which is incorporated herein in its entirety by reference.

### TECHNICAL FIELD

The present disclosure relates to a meal suggestion device, a meal suggestion method, and a meal suggestion program.

### BACKGROUND ART

Reference Literature 1 (JP 2002-334158 A) describes a unified health and meal management system that notifies employees of recommended menus based on employee data.

### SUMMARY

An example of an object of the present disclosure is to suggest a meal to a target person after clarifying a reason for selection.

An aspect of a meal suggestion device includes at least one memory configured to store instructions; and at least one processor configured to execute the instructions to: acquire target person related data related to a target person to whom a meal is to be suggested; determine a suggested meal to be suggested to the target person using the target person related data; generate basis information indicating a basis for suggesting the suggested meal; and present the suggested meal and the basis information.

An aspect of a meal suggestion method includes at least one processor acquiring target person related data related to a target person to whom a meal is to be suggested, determining a suggested meal to be suggested to the target person using the target person related data, generating basis information indicating a basis for suggesting the suggested meal, presenting the meal to be suggested, and presenting the basis information.

An aspect of a program causes a computer to execute: acquire target person related data related to a target person to whom a meal is to be suggested; determine a suggested meal to be suggested to the target person using the target person related data; generate basis information indicating a basis for suggesting the suggested meal; and present the suggested meal and the basis information.

The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 illustrates an overall configuration of a meal suggestion system according to the present disclosure;

FIG. 2 illustrates a hardware configuration of the meal suggestion device;

FIG. 3 is a block diagram of the meal suggestion device according to the present disclosure;

FIG. 4 illustrates an example of employee related data according to the present disclosure;

FIG. 5 illustrates a presentation example according to the present disclosure;

FIG. 6 illustrates a flowchart according to the present disclosure;

FIG. 7 is a block diagram of the meal suggestion device according to the present disclosure;

FIG. 8 illustrates a presentation example according to the present disclosure;

FIG. 9 illustrates a flowchart according to the present disclosure;

FIG. 10 illustrates an example of meal information according to the present disclosure;

FIG. 11 illustrates a presentation example according to the present disclosure;

FIG. 12 is a block diagram of a meal suggestion device according to the present disclosure;

FIG. 13 is a block diagram of a meal suggestion device according to the present disclosure;

FIG. 14 illustrates a presentation example according to the present disclosure;

FIG. 15 illustrates a flowchart according to the present disclosure;

FIG. 16 is a block diagram of a meal suggestion device according to the present disclosure; and

FIG. 17 illustrates a presentation example according to the present disclosure.

### EXAMPLE EMBODIMENT

Hereinafter, preferred example embodiments of the present disclosure will be described with reference to the drawings. In the present example embodiment, an example in which the target person to whom the meal is to be suggested is an employee will be described, but the target person to whom the meal is to be suggested in the present disclosure is not limited to an employee. For example, the target person may be a user who goes to a fitness gym, a hospitalized patient in a hospital, a resident of an elderly facility, or the like.

### First Example Embodiment

### (Overall Configuration)

In a First example embodiment, a meal suggestion system that suggests a meal after clarifying a reason for selection to an employee will be described.

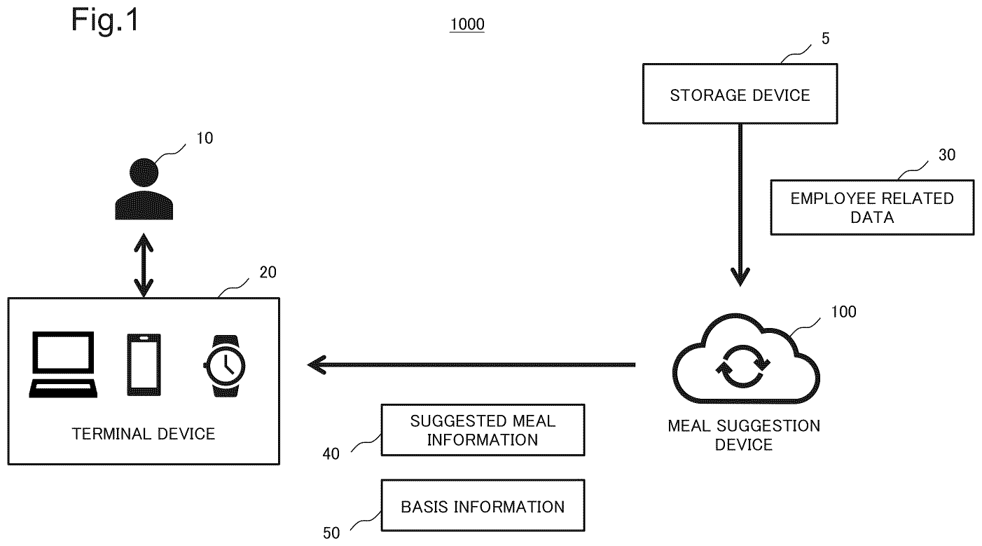

FIG. 1 illustrates an overall configuration of a meal suggestion system 1000 according to a first example embodiment. The meal suggestion system includes a terminal device 20 used by a user such as a target employee 10 to whom a meal is to be suggested, a meal suggestion device 100, and a storage device 5.

The meal suggestion device 100 generates suggested meal information 40 and the basis information 50 for the target employee 10 based on the employee related data 30, and transmits the information to the terminal device 20. The employee related data 30 relates to the target person related data for the target person.

### (Hardware Configuration)

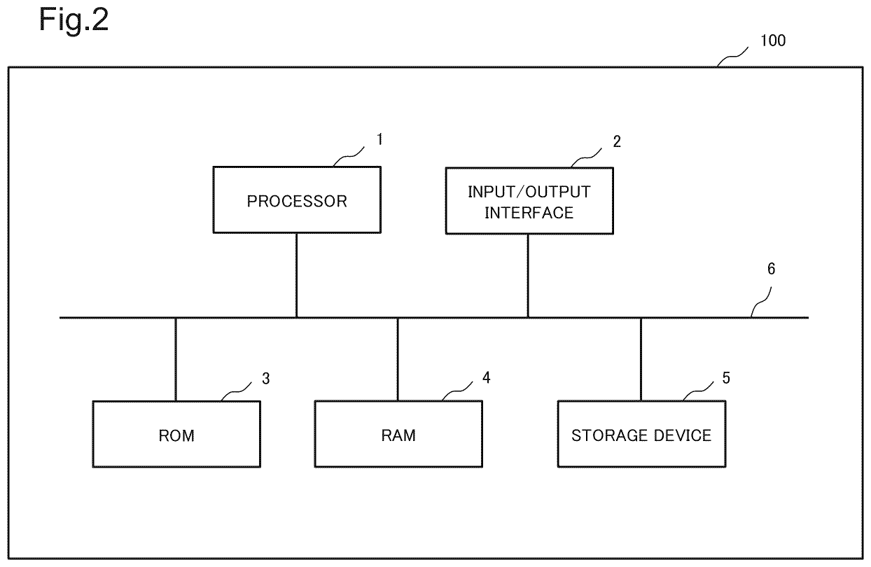

FIG. 2 is a block diagram illustrating a hardware configuration of the meal suggestion device 100. As illustrated in the drawing, the meal suggestion device 100 includes a processor 1, an input/output interface 2, read only memory (ROM) 3, random access memory (RAM) 4, and the storage device 5. The components are connected through, for example, a bus 6.

The processor 1 is a computer such as a central processing unit (CPU), and controls the entire meal suggestion device 100 by executing a meal suggestion program prepared in advance. Specifically, examples of the processor 1 can include a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof.

The processor 1 loads a program stored in the ROM 3, the storage device 5, or the like. Then, the processor 1 executes each process coded in the program. The processor 1 also functions as part or all of the meal suggestion device 100. The processor 1 may execute processing or instructions in a flowchart to be described later based on the program.

The input/output interface 2 is an interface for the meal suggestion device 100 to transmit/receive data to/from another device. For example, the meal suggestion device 100 acquires various pieces of data regarding the target employee 10 by communicating with the terminal device 20 via the input/output interface. The meal suggestion device 100 transmits the generated suggested meal information 40 and the basis information 50 to the terminal device 20 via the input/output interface 2.

The ROM 3 stores various programs executed by the processor 1. The RAM 4 is used as a working memory during execution of various processes by the processor 1.

The storage device 5 is a non-volatile non-transitory storage device. For example, the storage device 5 may be a disk-shaped recording medium, a semiconductor memory, or the like. Storage device 5 may be configured to be detachable from the meal suggestion device 100. The storage device 5 records various programs executed by the processor 1. A machine learning model, learning data, and the like used in the health condition prediction process to be described later may be stored.

### (Functional Configuration)

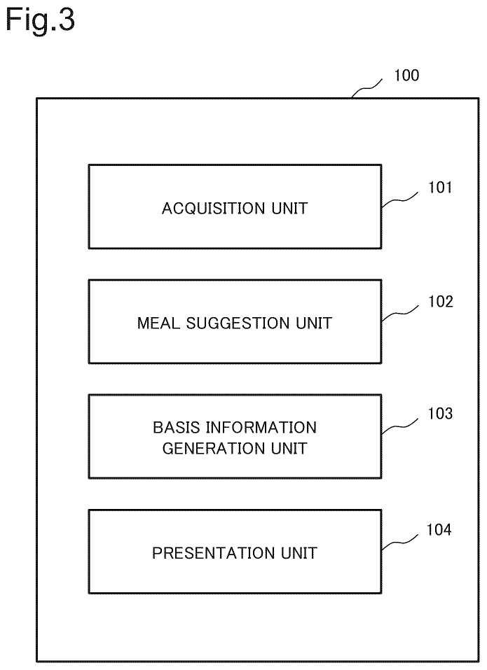

FIG. 3 is a block diagram illustrating a configuration of the meal suggestion device 100. The meal suggestion device 100 functionally includes an acquisition unit 101, a meal suggestion unit 102, a basis information generation unit 103, and a presentation unit 104.

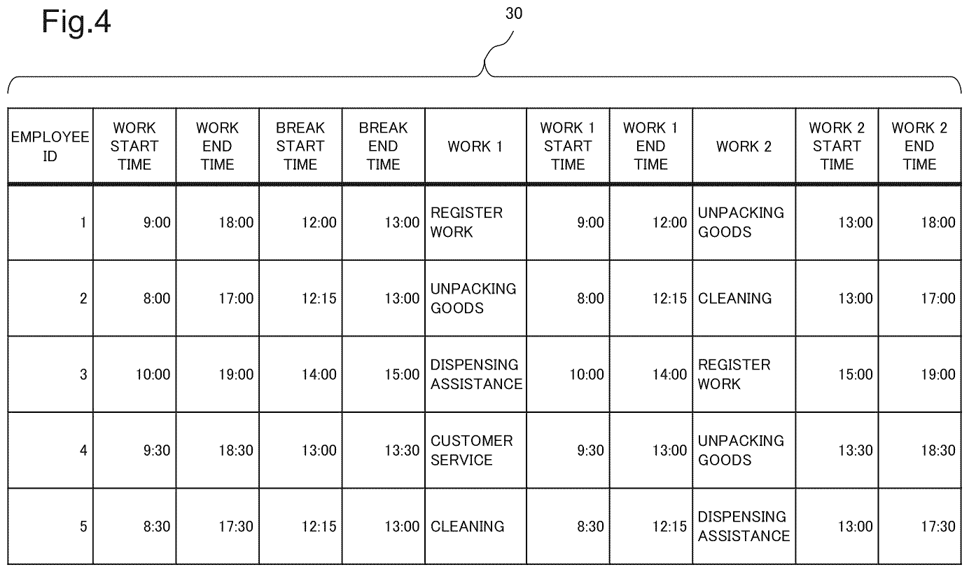

The acquisition unit 101 acquires the employee related data 30 that is data related to the target employee 10. The acquisition unit 101 may acquire the employee related data 30 from the storage device 5. Alternatively, the employee related data 30 input via the device used by the employee may be acquired. The employee related data 30 is information about the target employee 10. FIG. 4 illustrates an example of the employee related data 30. The employee related data 30 illustrated in FIG. 4 includes an employee identification (ID) that is identification information of the target employee 10, a work start time, a work end time, a break start time, a break end time, content of a work 1 performed by the target employee 10, a work 1 start time, a work 1 end time, content of a work 2 performed by the target employee 10, a work 2 start time, and a work 2 end time. In this manner, the employee related data 30 may include data related to the work schedule of the employee. The employee related data 30 may further include not only a work schedule but also an actual work situation. The employee related data 30 may include a behavior history of the target employee 10 (activity amount, number of steps, posture information, travel distance, commuting time, commuting route, etc.) or a communication history with other employees and customers (conversation content, mail content, chat content, reaction content, emotion data between the employee and communication partner associated with communication, and the like). The employee related data 30 may include information about stress of the employee. For example, the employee related data 30 may include a stress value estimated based on commuting time. For example, in a case where the commuting time is longer than usual, since the possibility that stress is accumulated increases, the employee related data 30 may include information indicating the stress level of the employee.

The employee related data 30 may include the result of the medical examination of the target employee 10 (height, weight, body fat percentage, body age, body mass index (BMI), basal metabolism, visceral fat level, and the like). The employee related data 30 may include weather, temperature, pedometer measurement information (date, number of steps, number of steps per time zone, etc.), sphygmomanometer measurement information (maximum blood pressure, minimum blood pressure, pulse rate, measurement time, etc.), weight measurement information (weight measurement time, etc.), vital data (pulse, respiration, body temperature, etc.), life information (mood, physical condition, meal, exercise, sleep, smoking status, drinking status, etc.), attribute information (nickname, gender, date of birth, age, family structure, and the like of the target employee 10), sleep related data (measurement date, actual sleep time, sleeping time, awakening time, hour, and number of times, quality of sleep, number of times of snoring, snoring level, etc.), and the like. The employee related data 30 may include intake meal information indicating an intake meal. For example, the intake meal information includes content, calories, and intake time of a meal (breast, lunch, dinner, etc.), a type and an intake amount of a drink, and an intake amount of each nutrient (proteins, carbohydrates, lipids, vitamins, and the like).

The meal suggestion unit 102 determines a meal to be suggested to the target employee 10 using a meal selection model that machine learned a relationship between the employee related data 30 and the suggested meal information 40. The employee related data 30 used for the machine learning of the meal selection model may be any data collected for an any target person. The target person may or may not include the target employee 10. The suggested meal information 40 may include, for example, information such as a food name, an ingredient, calorie information of a meal, nutrition information, a providing place, and a providing place address. The meal suggestion unit 102 determines a meal to be suggested to the target employee 10 using a meal selection model that machine learned a relationship between data to be considered in determining a meal to be suggested and a meal related to the data. Data to be considered in determining a meal to be suggested may be included in the employee related data 30. For example, a meal to be suggested may be determined in consideration of working hours, content of work performed, age, and nutrients of a meal taken most recently. In this case, the meal suggestion unit 102 determines a meal to be suggested by using a meal selection model that presents information indicating a meal to be suggested by inputting data (a feature amount to be described later) indicating the working hours, the content of work that has been performed, the age, and the nutrients of the meal that has been taken most recently.

The output of the meal selection model may indicate a specific meal (for example, information indicating a menu name, a dish name, and the like.) or may indicate a condition that the meal should satisfy (for example, calories, ingredients, nutrients, prices, etc.). In the latter case, the meal suggestion unit 102 may generate suggested meal information 40 indicating the output condition, or may search for a meal satisfying the output condition and generate suggested meal information 40 indicating the detected meal. The suggested “meal” may be any food that the target employee 10 can eat, and can be rephrased as, for example, a menu, a dish, a food product, a menu, or a food.

In the present example embodiment, an example in which the meal suggestion unit 102 calculates the suggested meal information 40 as an output result of the meal selection model will be described. The suggested meal information 40 is information about a meal (food) to be suggested to the target employee 10. A form of the suggested meal information 40 is not particularly limited, and may include, for example, an item name of a meal, a providing place, calories, and nutrients (proteins, carbohydrates, lipids, vitamins, and the like). The meal selection model is a model that was machine trained using learning data for the meal selection model, and may be stored in, for example, the storage device 5 or the like. The meal selection model may be generated by a known machine learning algorithm (for example, random forest, support vector machine, naïve Bayes, neural network, or the like). A plurality of meals may be suggested using a plurality of output values of the model. The learning data for the meal selection model is data in which an explanatory variable (a feature amount to be described later) serving as an input to the meal selection model is associated with an objective variable serving as an output from the meal selection model.

The objective variable of the meal selection model is used to generate suggested meal information 40. The explanatory variable of the meal selection model is generated from the employee related data 30. For example, the learning data may be created by associating information indicating a meal suggested by a dietitian or the like having specialized knowledge as an objective variable with an explanatory variable generated from the employee related data 30. As described above, the employee related data 30 may include information indicating the degree of stress, and in this case, the information indicating the degree of stress may be used as an explanatory variable. In a case where the information indicating the degree of stress is used as an explanatory variable, the explanatory variable may be associated with information indicating a meal suggested by a social insurance labor consultant, an industrial consultant, or the like having specialized knowledge about labor as an objective variable.

The meal suggestion device 100 may include a function of generating learning data, that is, a learning data generation unit. The learning data generation unit generates learning data by associating the suggested meal information 40 with the acquired known employee related data 30 with respect to the known employee related data 30. The learning data generation unit may generate learning data after performing preprocessing such as data cleansing, data integration, and data conversion on the employee related data 30. The meal suggestion device 100 may include a function of generating a meal selection model using learning data, that is, a meal selection learning unit. The meal selection learning unit generates a meal selection model machine trained using learning data. When the employee related data 30 acquired by the acquisition unit 101 is input, the meal selection model generated using the learning data outputs the suggested meal information 40 based on the learning result.

The meal suggestion unit 102 may determine a meal based on the meal selection rule base without using the meal selection model. The meal selection rule base stores a rule of selecting a certain meal in a case where the employee related data 30 satisfies a certain condition. For example, the meal selection rule base may store a rule in which “selecting a meal having X (kcal) or more” is associated with a condition that “content of work is unpacking goods”. For example, the meal selection rule base may store a rule in which “selecting a sweet food such as a dessert” is associated with a condition that “the emotion data of the target employee 10 for the communication partner is anger”. The timing at which the meal suggestion unit 102 determines a meal is not particularly limited. For example, it may be at the end of work, at the start of a break, at the time of work change, or the like.

The basis information generation unit 103 generates the basis information 50 based on the degree of contribution of the feature amount input to the meal selection model to the output value of the meal selection model. The feature amount is an explanatory variable of the meal selection model, and is either or both of data extracted from the employee related data 30 and data obtained by processing the employee related data 30. For example, the basis information generation unit 103 can use an XAI (explainable AI, Explainable AI) algorithm to calculate the degree of contribution of each feature amount to the output value of the meal selection model. Hereinafter, an example in which the basis information generation unit 103 uses local interpretable model-agnostic explanations (LIME) that are XAI will be described. The detailed operation of LIME will be described below. The basis information generation unit 103 may use another XAI algorithm (for example, Shapley Additive explanations (SHAP), and the like) instead of LIME.

LIME used by the basis information generation unit 103 will be described. LIME is a method of estimating a degree of contribution of a feature amount to an output result from a change in the feature amount and a change in the output result of the model. The calculation method is expressed by the following Expression (1).

$$\begin{matrix}[ Math . 1 ] & \\ {min}_{{a}_{1} , {a}_{2} , … , {a}_{d}} \frac{1}{2} {\sum }_{n = 1}^{N} {( {\tilde{y}}^{( n )} - y - {\sum }_{i = 1}^{d} {a}_{i} {ϵ}_{i}^{( n )} )}^{2} & ( 1 )\end{matrix}$$

$$\begin{matrix}[ Math . 2 ] & \\ {\tilde{y}}^{( n )} & ( 2 )\end{matrix}$$

Expression (2) is an output result for a value obtained by randomly changing the feature amount input to the meal selection model, where y is an output result for a value of the feature amount input to the meal selection model. aᵢ is a parameter (variable) indicating the degree of contribution of each feature amount xᵢ to the output result.

εᵢ⁽ⁿ⁾ is a difference between the respective feature amounts xᵢ, and means a degree of change in the feature amount when the feature amount is randomly changed.

N is the number of random samples, and d is the number of feature amounts. Basis information generation unit 103 derives aᵢ that minimizes the term of Expression (1), and sets the derived aᵢ as the degree of contribution of each feature amount to the output result. That is, the basis information generation unit 103 calculates aᵢ by solving an optimization problem for obtaining aᵢ that minimizes a sum of squares error between the output result of the meal selection model and the output result of the approximate model obtained by approximating the meal selection model using aᵢ.

The basis information generation unit 103 may select a feature amount to be presented as the basis information 50 based on the calculated degree of contribution. For example, the basis information generation unit 103 may present, as the basis information 50, a feature amount having a relatively high degree of contribution or a feature amount having a degree of contribution equal to or more than a predetermined threshold value among the feature amounts whose degrees of contribution are calculated using the above-described Expression (1). Basis information 50 may indicate a feature amount and a degree of contribution thereof.

In a case where meal suggestion unit 102 selects a meal based on the meal selection rule base, the basis information generation unit 103 may generate the basis information 50 indicating a condition satisfied in the meal selection rule base. For example, in a case where “meal having X (kcal) or more” is selected by satisfying a condition that “content of work was unpacking goods”, the basis information generation unit 103 may generate the basis information 50 indicating that “content of work was unpacking goods”.

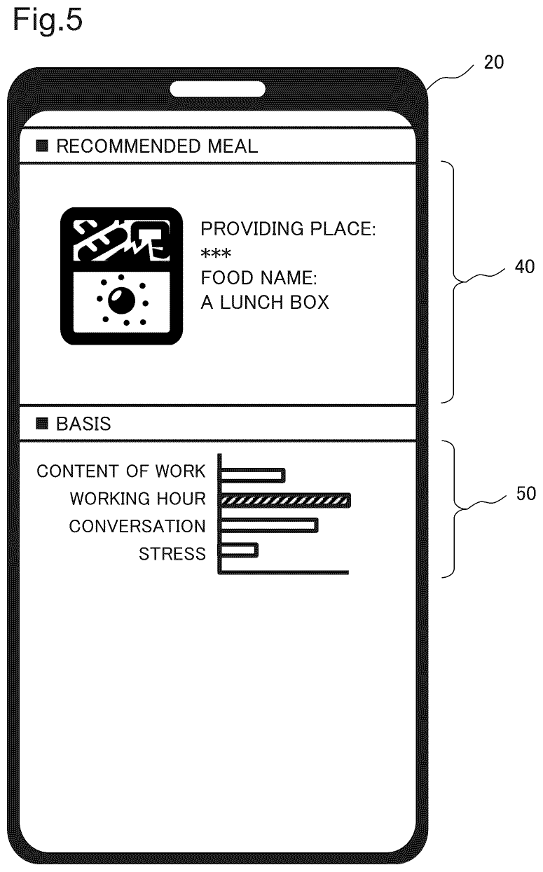

Presentation unit 104 presents the suggested meal information 40 selected by the meal suggestion unit 102 and the basis information 50 calculated by the basis information generation unit 103 to the terminal device 20. FIG. 5 illustrates an example of presentation to the terminal device 20 according to the first example embodiment. As illustrated in FIG. 5, the suggested meal information 40 may be, for example, information indicating a meal providing place in addition to a food name. The suggested meal information 40 may include related information such as ingredients, calories, and nutrition information of a suggested meal. The suggested meal information 40 may include an address of a providing place. As illustrated in FIG. 5, the basis information 50 may include a feature amount and a degree of contribution thereof. As illustrated in FIG. 5, the basis information 50 may indicate the degree of contribution of each feature amount in a graph. As a result, it is possible to suggest a meal to the target employee 10 after clarifying the reason for the suggestion. The person who browses the suggested meal information 40 and the basis information 50 presented by the presentation unit 104 is not limited to the target employee 10, but may be another user. The another user may be, for example, a boss of the target employee 10, an industrial physician at a place where the target employee 10 works, or the like. The presentation mode of the suggested meal information 40 and the basis information 50 is not limited to display, but may be presented in a mode such as voice or printing.

### (Information Process)

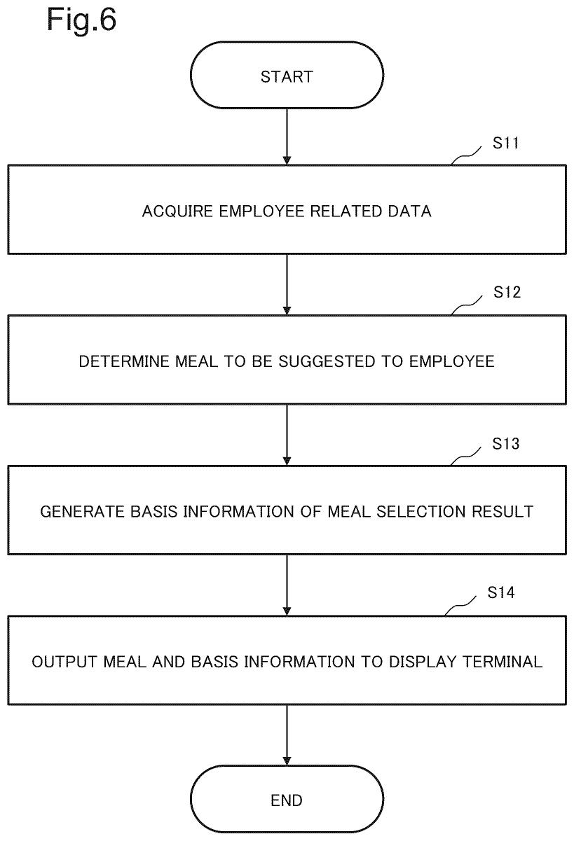

FIG. 6 is a flowchart of a process by the meal suggestion device 100 of the first example embodiment. This process is implemented by the processor 1 illustrated in FIG. 2 executing a program prepared in advance and operating as respective elements illustrated in FIG. 3.

First, the acquisition unit 101 acquires the employee related data 30 (step S11). Next, the meal suggestion unit 102 determines a meal to be suggested to the target employee 10 from the employee related data 30 acquired in S11 using a meal selection model that machine learned the relationship between the employee related data 30 and the suggested meal information 40 (step S12). Next, the basis information generation unit 103 generates the basis information 50 for the prediction result of each feature amount used for the prediction based on the meal selection model used for the prediction in S12 and the employee related data 30 acquired by the acquisition unit 101 in S11 (step S13). The degree of contribution to the prediction result for calculating the basis information 50 can be calculated by using, for example, the XAI algorithm as described above. Next, the presentation unit 104 presents the suggested meal information 40 and the basis information 50 to the terminal device 20 (step S14). This is the end of the process.

As described above, in the first example embodiment, it is possible to suggest a meal to the target employee 10 after clarifying the reason for selection.

### (First Modification)

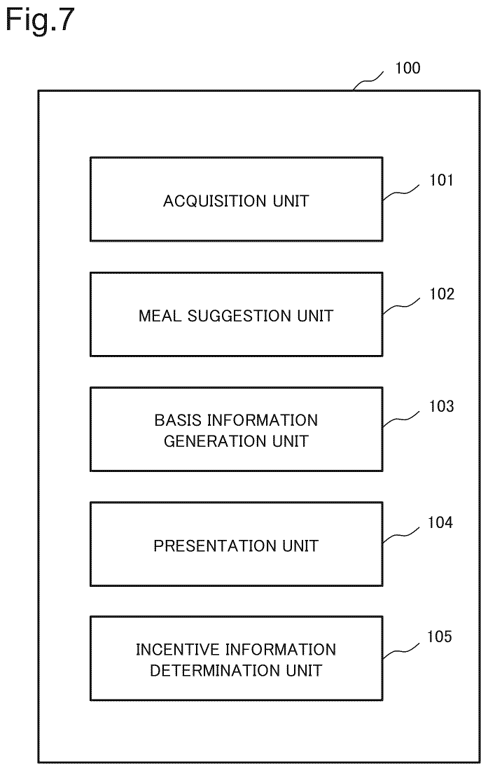

In the first example embodiment, the meal suggestion device 100 includes the acquisition unit 101, the meal suggestion unit 102, the basis information generation unit 103, and the presentation unit 104, and determines a meal to be suggested to the target employee 10. Further, as a modification, an incentive information determination unit 105 may be provided. FIG. 7 is a block diagram illustrating a configuration of the meal suggestion device 100 according to the first modification.

The incentive information determination unit 105 determines the incentive information 60 related to the suggested meal information 40. The incentive information 60 is information that motivates the presented person to take action. For example, the incentive information 60 may be in the form of a coupon, a point, a gift voucher, electronic money, a goods exchange voucher, or the like related to the suggested meal information 40. The incentive information 60 can encourage the target employee 10 to actually purchase the suggested meal.

The incentive information determination unit 105 may determine the incentive information 60 related to the suggested meal information 40 based on the incentive information database stored in the storage device 5. The incentive information database store, for example, the type of incentive, the content of the incentive, the target food, the determination condition, and the like. The incentive information database may include best-before date (consume by date) information, inventory information, and the like of the target food, and the incentive information determination unit 105 may determine the incentive information 60 related to a food whose best-before date (consume by date) is approaching as the incentive information 60 related to the suggested meal information 40.

For example, in a case where the target employee 10 works in a supermarket, the incentive information database may include a product database used in the supermarket. The product database includes a product name, a product type, a best-before date (consume by date), an inventory quantity, an inventory store, and the like. The incentive information database stores a combination of the incentive information 60 with a product whose consume by date is within X hours and whose product type is a daily dish.

The presentation unit 104 presents the suggested meal information 40 determined by the meal suggestion unit 102, the basis information 50 calculated by the basis information generation unit 103, and the incentive information 60 determined by the incentive information determination unit 105 to the terminal device 20. The presentation of the suggested meal information 40 and the basis information 50 is similar to that in the above example embodiment. The incentive information 60 may be, for example, a coupon applicable to the target employee 10 in a case of purchasing the suggested meal information 40 or a point granted to the target employee 10 when purchasing the suggested meal information 40. The incentive information 60 may include a coupon, a point, a gift voucher, electronic money, a goods exchange voucher, or the like related to the suggested meal information 40. As a result, the meal suggestion device 100 of the first modification can suggest a meal to the target employee 10 after clarifying the reason for selection together with the incentive information 60. The presentation mode of the incentive information 60 is not limited to display, but may be presented in a mode such as voice or printing.

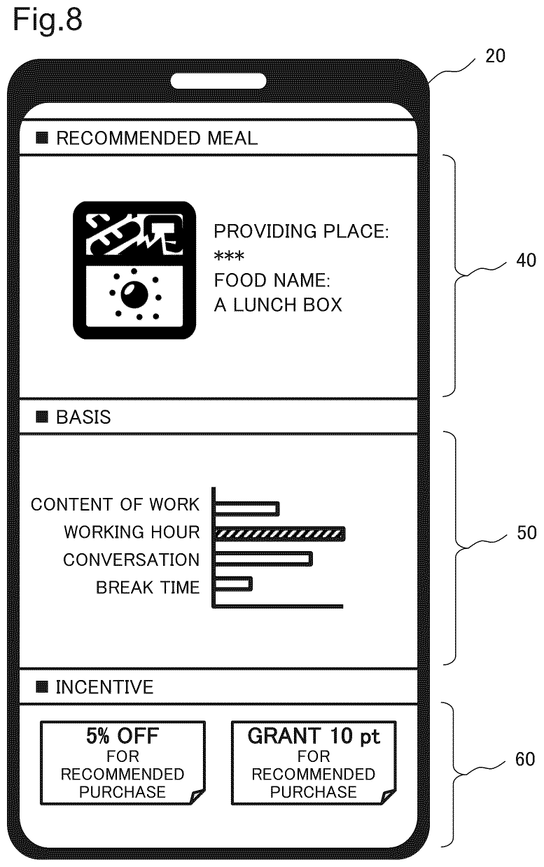

FIG. 8 illustrates an example of presentation to the terminal device 20 in the first modification. The presentation example of FIG. 8 is different from the presentation example of FIG. 5 in that the incentive information 60 is displayed. The incentive information 60 illustrated in FIG. 8 displays a coupon by which a discount of the purchase price of “A lunch box” indicated in the suggested meal information 40 can be received and a coupon by which a point can be obtained at the time of purchase of “A lunch box”. The target employee 10 can enjoy benefits such as a discount and granting of points by presenting this coupon at the time of purchase of “A lunch box”, for example.

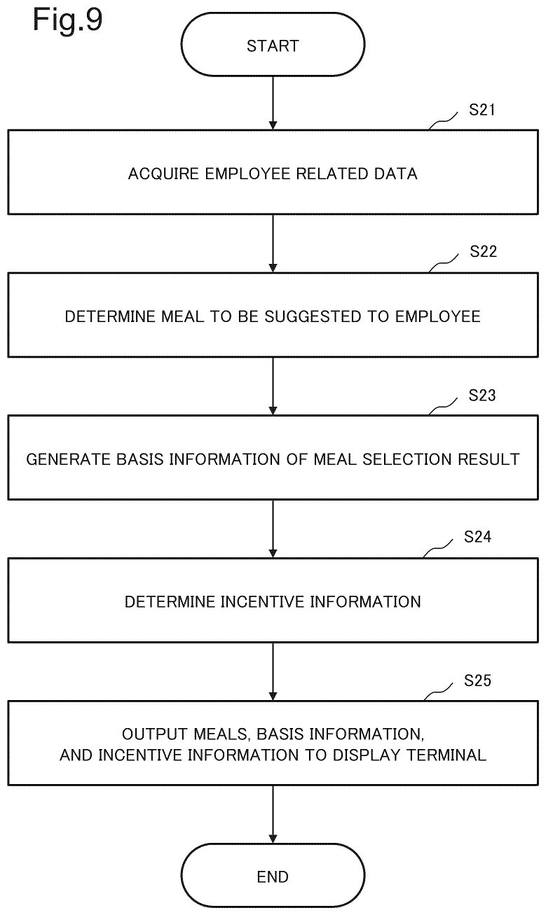

FIG. 9 is a flowchart of a process by the meal suggestion device 100 of the first modification. This process is implemented by the processor 1 illustrated in FIG. 2 executing a program prepared in advance and operating as respective elements illustrated in FIG. 7.

First, the acquisition unit 101 acquires the employee related data 30 (step S21). Next, the meal suggestion unit 102 determines a meal to be suggested to the target employee 10 from the employee related data 30 acquired in S21 using a meal selection model that machine learned the relationship between the employee related data 30 and the suggested meal information 40 (step S22). Next, the basis information generation unit 103 generates the basis information 50 for the prediction result of each feature amount used for the prediction based on the meal selection model used for the prediction in S22 and the employee related data 30 acquired by the acquisition unit 101 in S21 (step S23). The degree of contribution to the prediction result for calculating the basis information 50 can be calculated by using, for example, the XAI algorithm as described above. Next, the incentive information determination unit 105 determines the incentive information 60 related to the suggested meal information 40 determined in S23 (step S24). Next, the presentation unit 104 presents the suggested meal information 40, the basis information 50, and the incentive information 60 to the terminal device 20 (step S25). This is the end of the process.

### (Second Modification)

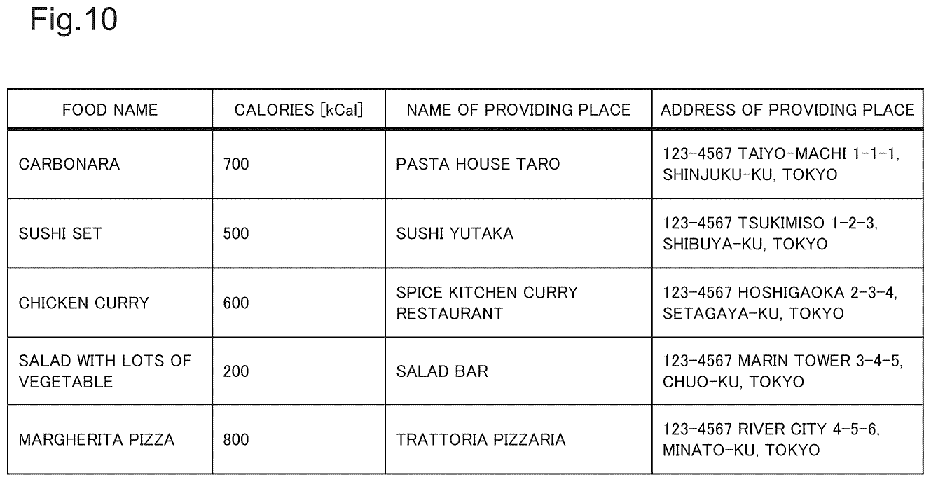

In the first example embodiment, the suggested meal information 40 may be determined based on the position information of the employee. In this case, the acquisition unit 101 acquires position information indicating the position of the employee as the employee related data 30. The meal information that is a candidate for the suggested meal information 40 includes an address of a meal providing place. FIG. 10 illustrates an example of meal information. In addition to the providing place address, the meal information may include a food name, calories, a providing place name, and the like.

The meal suggestion unit 102 determines a meal to be suggested to the target employee 10 using a meal selection model that machine learned a relationship between the employee related data 30 and the suggested meal information 40. In the second modification, by including the position information of the employee and the address of the meal providing place as the learning data for the meal selection model, it is possible to suggest a meal in consideration of the distance between the employee and the meal providing place and the required time. For example, as the learning data, meal information (objective variable) in such a way that the break time of the employee included in the employee related data 30 is longer than the required travel time calculated from the address of the meal providing place and the position information of the employee is combined with the employee related data 30 as an explanatory variable. This makes it possible to suggest a meal in accordance with the position information of the target employee 10.

The meal suggestion unit 102 may determine a meal provided at a place within a predetermined range from the location of the target employee 10 among the meals determined using the meal selection model described in the first example embodiment as a meal to be suggested to the target employee 10. In this case, the meal suggestion unit 102 identifies the location of the target employee 10 from the position information of the target employee 10, and identifies the place where the meal determined using the meal selection model is provided. When the identified providing place is within a predetermined range from the location of the target employee 10, the meal suggestion unit 102 determines the meal as a meal to be suggested to the target employee 10. The predetermined range may be defined by a linear distance from the location to the providing place, may be defined by a distance of a route from the location to the providing place, or may be defined by a time required for moving from the location to the providing place. In a case where the employee related data 30 includes data indicating a break time or an average required time for a meal of the employee, the meal suggestion unit 102 may determine the above-described predetermined range based on the break time or the average required time for a meal.

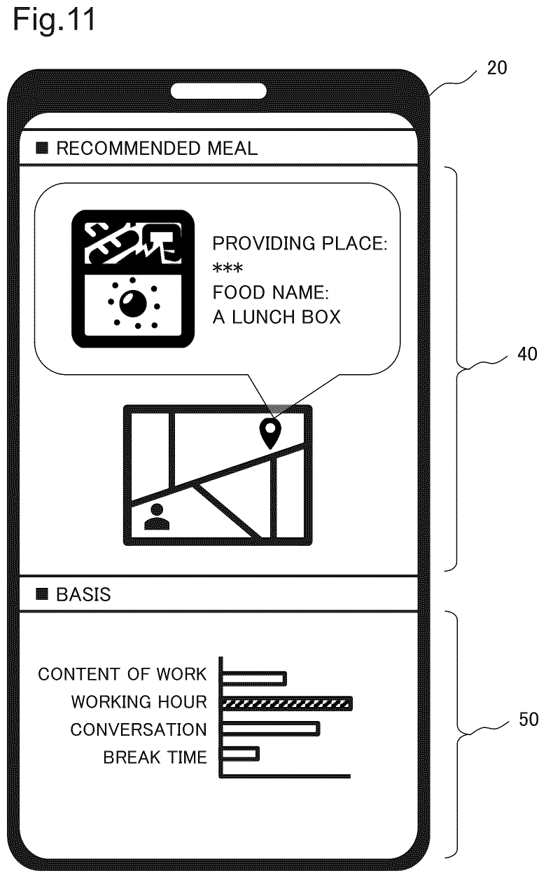

Presentation unit 104 presents the suggested meal information 40 and the basis information 50 to the terminal device 20. FIG. 11 illustrates an example of presentation to the terminal device 20. The presentation example of FIG. 11 is different from the presentation example of FIG. 5 in content of the suggested meal information 40. As in the example of FIG. 11, the presentation unit 104 may display the meal providing point and the position information of the employee on the map as the suggested meal information 40. The position information of the employee may be updated in a certain period of time. Presentation unit 104 may display, as the suggested meal information 40, information (for example, an icon) indicating the meal providing point and the position of the employee on a map displayed by an existing map application. The presentation mode of the suggested meal information 40 and the basis information 50 is not limited to display, but may be presented in a mode such as voice or printing.

### (Third Modification)

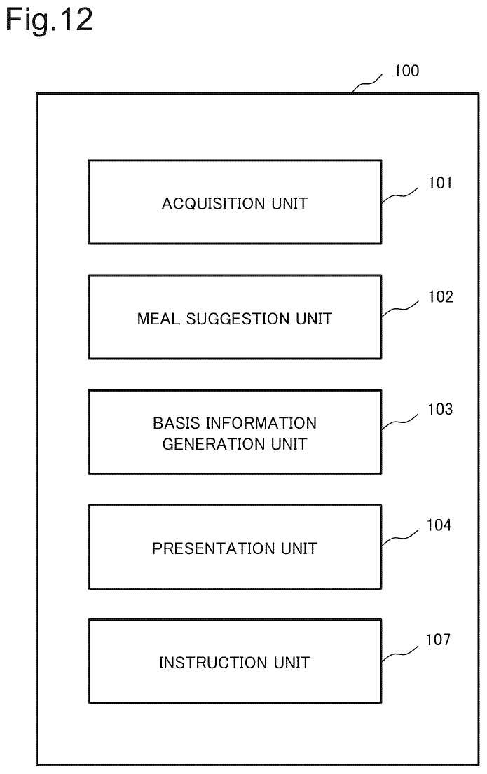

In the first example embodiment, the meal suggestion device 100 includes the acquisition unit 101, the meal suggestion unit 102, the basis information generation unit 103, and the presentation unit 104, and determines a meal to be suggested to the target employee 10. Further, as a modification, an instruction unit 107 may be provided. FIG. 12 is a block diagram illustrating a configuration of the meal suggestion device 100 according to the third modification.

The instruction unit 107 provides an instruction necessary for the target employee 10 to eat the suggested meal. For example, the instruction unit 107 may instruct to deliver the suggested meal to the work place of the target employee 10. For example, the instruction unit 107 may instruct to deliver the suggested meal to the refrigerated locker of the station by X o'clock.

For example, instruction unit 107 may order a suggested meal. In a case where the target employee 10 goes to the place where the meal is provided, the instruction unit 107 may place an order or make a reservation in such a way that the meal is provided at the estimated time of arrival. The instruction unit 107 may place an order for take-out of a meal.

Instruction unit 107 may transmit the instruction to the store that provides the meal. The instruction unit 107 may transmit the instruction content to another delivery ordering system. For example, the delivery ordering system receives a delivery order to a store and places an order to a delivery company. This facilitates the target employee 10 to actually take in the suggested meal.

### Second Example Embodiment

Next, the second example embodiment of the present disclosure will be described. The second example embodiment is different from the first example embodiment in the following points. Meal suggestion device 100 of the second example embodiment includes a route optimization unit 106 that optimizes a route passing through the place where the suggested meal is provided, and the presentation unit 104 further presents optimal route information in addition to the suggested meal information 40 and the basis information 50. The second example embodiment is similar to the first example embodiment except for these points. Specifically, the overall configuration of a meal suggestion system 1000 and the hardware configuration of the meal suggestion device 100 of the second example embodiment are similar to the overall configuration illustrated in FIG. 1 and the hardware configuration illustrated in FIG. 2 of the first example embodiment, and thus, the description thereof will be omitted.

### (Functional Configuration)

FIG. 12 is a block diagram illustrating a functional configuration of the meal suggestion device 100. As illustrated in the drawing, the meal suggestion device 100 of the second example embodiment includes the acquisition unit 101, the meal suggestion unit 102, the basis information generation unit 103, the presentation unit 104, and the route optimization unit 106. The acquisition unit 101, the meal suggestion unit 102, and a basis information generation unit 103 are the same as those in the first example embodiment, and thus description thereof is omitted.

The route optimization unit 106 optimizes a route passing through the place where the suggested meal is provided based on a mathematical optimization calculation method using a constraint condition including at least part of the suggested meal information 40 and the employee related data 30 as a condition.

The mathematical optimization calculation method is a method of defining a certain problem as a mathematical expression and obtaining a value of a variable that minimizes or maximizes an objective function while satisfying a constraint condition. For example, known algorithms may be used, such as dynamic programming, a greedy method, an approximate algorithm, and the like.

First, the route optimization unit 106 receives map data and a constraint condition. The map data may include road data, building data, topographic data, traffic data, facility information, noise indices of facilities and roads, and the like.

The constraint condition is a condition that optimal route information 70 should satisfy, and includes at least part of the suggested meal information 40 and the employee related data 30 as a condition. For example, the constraint condition includes a condition that “the target employee 10 passes through the place where the meal is provided”, “the target employee 10 walks for X minutes or more”, “the required time of the route is equal to or less than the break time of the target employee 10”, “the route passes through a park”, and “the route passes through a slope”. The constraint condition can be set and changed by the target employee 10.

Next, the route optimization unit 106 generates an objective function. The objective function is a function to be maximized or minimized in the mathematical optimization calculation method. The evaluation items included in the objective function include, for example, “the travel distance of the target employee 10”, “the travel time of the target employee 10”, and “the sum of noise indices of places and roads where the target employee 10 stops by”. A weight value may be set for each evaluation item. The evaluation item and the weight value may vary based on the employee related data 30. The evaluation item and the weight can be set and changed by the target employee 10.

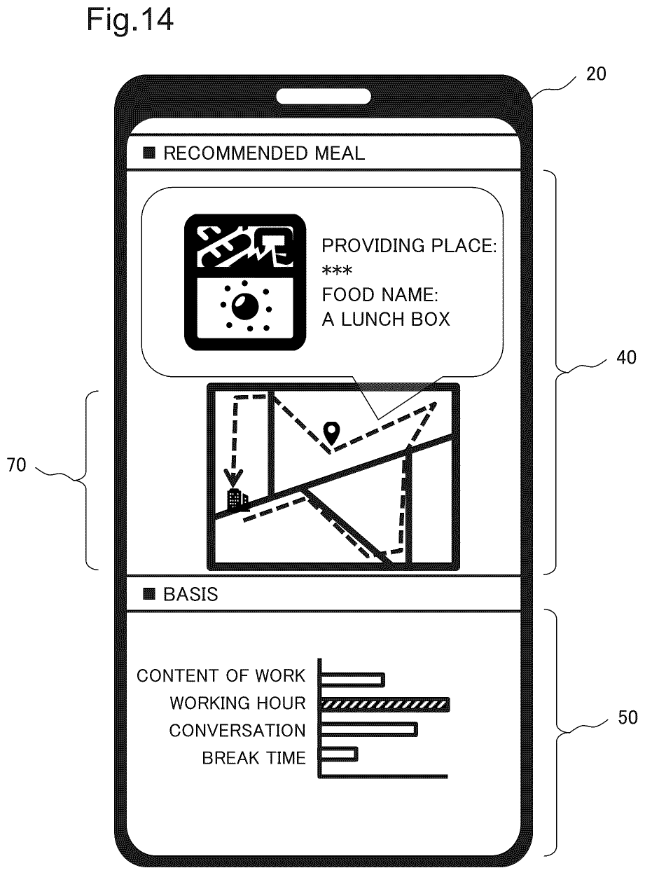

The presentation unit 104 presents the suggested meal information 40 determined by the meal suggestion unit 102, the basis information 50 calculated by the basis information generation unit 103, and the optimal route information 70 to the terminal device 20. FIG. 14 illustrates an example of presentation to the terminal device 20 according to the second example embodiment. Outputs of the suggested meal information 40 and the basis information 50 are similar to those in the first example embodiment. The optimal route information 70 may be, for example, a line (for example, a dotted line) indicating the optimal route displayed on a map. The optimal route information 70 may be displayed on a map output as the suggested meal information 40. As a result, it is possible to suggest a meal to the target employee 10 with the optimal route to the providing place where the suggested menu is provided. The presentation mode of the suggested meal information 40, the basis information 50, and the optimal route information 70 is not limited to display, but may be output in a mode such as voice or printing.

### (Information Process)

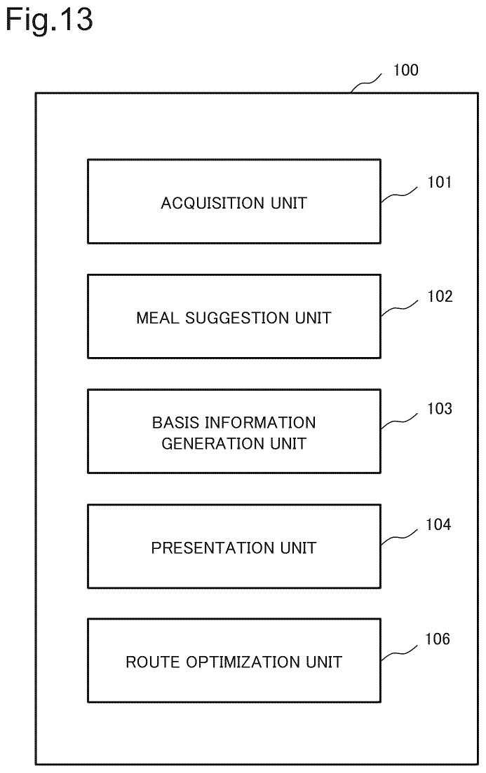

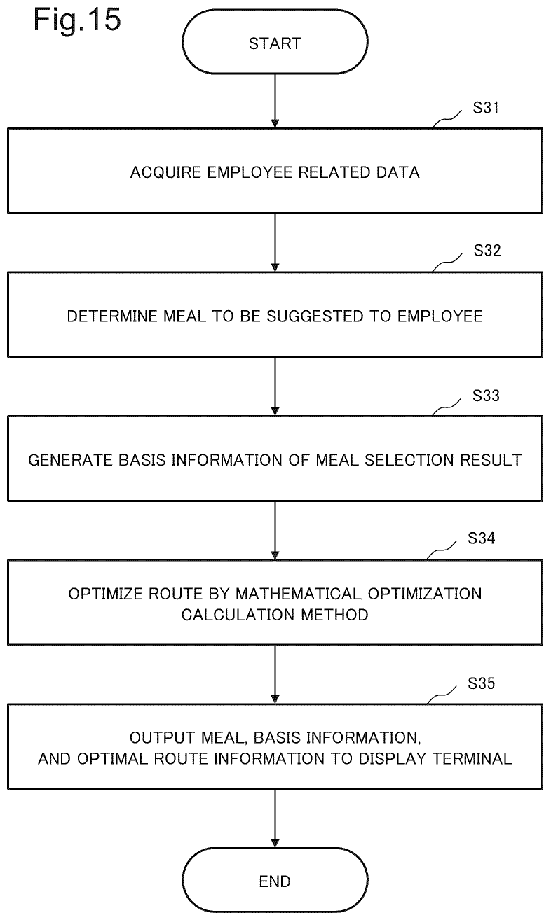

FIG. 15 is a flowchart of a process by the meal suggestion device 100 of the second example embodiment. This process is implemented by the processor 1 illustrated in FIG. 2 executing a program prepared in advance and operating as respective elements illustrated in FIG. 13.

First, the acquisition unit 101 acquires the employee related data 30 (step S31). Next, the meal suggestion unit 102 determines a meal to be suggested to the target employee 10 from the employee related data 30 acquired in S31 using a meal selection model that machine learned the relationship between the employee related data 30 and the suggested meal information 40 (step S32). Next, the basis information generation unit 103 generates the basis information 50 for the prediction result of each feature amount used for the prediction based on the meal selection model used for the prediction in S32 and the employee related data 30 acquired by the acquisition unit 101 in S31 (step S33). The degree of contribution to the prediction result for calculating the basis information 50 can be calculated by using, for example, the XAI algorithm as described above. Next, the route optimization unit 106 optimizes a route passing through the place where the suggested meal is provided based on the mathematical optimization calculation method (step S34). Next, the presentation unit 104 outputs the suggested meal information 40, the basis information 50, and the optimal route information 70 to the terminal device 20 (step S35). This is the end of the process.

As described above, in the second example embodiment, the meal can be suggested to the target employee 10 together with the optimal route after the selection reason is clarified.

### Third Example Embodiment

Next, the third example embodiment of the present disclosure will be described. The third example embodiment is different from the first example embodiment in the following two points. The first point is that the meal suggestion device 100 of the third example embodiment includes a sentence generation unit 108 in addition to respective units included in the meal suggestion device 100 of the first example embodiment. The sentence generation unit 108 generates a sentence (also referred to as a text) using the suggested meal information 40, the basis information 50, and a language model. The second point is that the presentation unit 104 outputs the sentence generated by the sentence generation unit 108. Except for these points, the third example embodiment is similar to the first example embodiment. Specifically, since the hardware configuration of the meal suggestion device 100 of the third example embodiment is similar to the hardware configuration illustrated in FIG. 2 of the first example embodiment, the description thereof is omitted.

### (Functional Configuration)

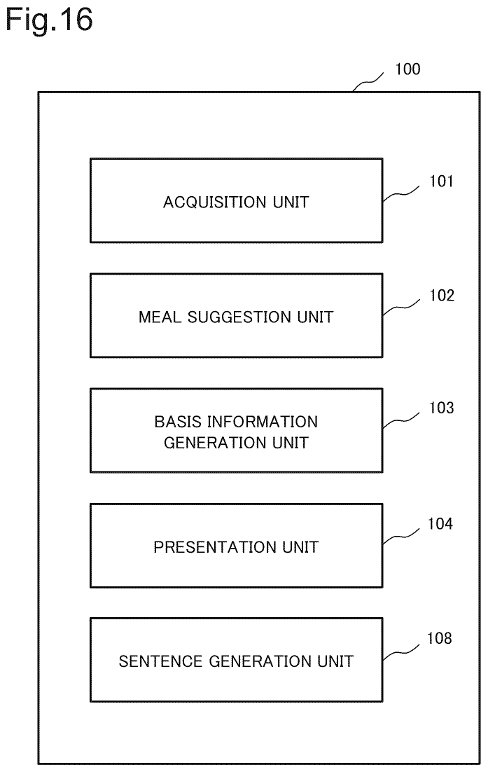

FIG. 16 is a block diagram illustrating a functional configuration of the meal suggestion device 100. As illustrated in the drawing, the meal suggestion device 100 of the third example embodiment includes the acquisition unit 101, the meal suggestion unit 102, the basis information generation unit 103, the presentation unit 104, and the sentence generation unit 108. The acquisition unit 101, the meal suggestion unit 102, and a basis information generation unit 103 are the same as those in the first example embodiment, and thus description thereof is omitted.

Sentence generation unit 108 generates a sentence using the suggested meal information 40, the basis information 50, and the language model. The sentence generation unit 108 transmits the generated sentence to the presentation unit 104. The presentation unit 104 outputs the sentence generated by the sentence generation unit 108.

### (Language Model)

In the present example embodiment, a language model used by the sentence generation unit 108 will be described. The language model is a model that learns a relationship between words in a sentence and generates a related character string related to a target character string from the target character string. By using a language model that was trained on texts and sentences in various contexts, it is possible to generate a related character string having appropriate content related to the target character string.

For example, a case where a language model is used in the question and answer will be described. The language model receives an input of a question “What country is Japan?” as the target character string. The language model generates a related character string such as “Japan is an island country in the Northern Hemisphere and . . . ” as an answer to the question.

A learning method of the language model is not particularly limited, but as an example, the language model may be trained in such a way as to output at least one sentence including an input character string.

As a specific example, the language model is a generative pre-training (GPT) model that outputs a sentence including an input character string by predicting a character string having a high probability following the input character string. In addition to this, for example, text-to-text transfer transformer (T5), bidirectional encoder representations from transformers (BERT), (robstly optimized BERT approach) (ROBERTa), and efficient learning an encoder that classifies token replacements accurately (ELECTRA) are also language models.

The above is the description of the language model. An outline of a method in which the sentence generation unit 108 generates a sentence using a language model will be described. First, the sentence generation unit 108 acquires an input sentence (prompt). The prompt is a sentence instructing generation of a sentence suggesting a meal to the employee, and includes either or both of the suggested meal information 40 and the basis information 50.

The language model may be stored in any storage device accessible by the meal suggestion device 100, such as the storage device 5, for example. The prompt may be stored in advance in the storage device 5 or the like, or may be generated by the sentence generation unit 108. For example, the sentence generation unit 108 can generate a prompt by inputting various pieces of information included in the suggested meal information 40 and the basis information 50 into a template generated in advance.

For example, the prompt has content such as “A meal along with the basis information is suggested to the employee. The suggested meal is a “stamina bowl” sold at the “energizing lunch box shop”. The stamina bowl has been suggested because the employee is involved in the work of “unpacking goods” in the morning and are expected to be physically tired. Please output the comment to this employee.” Such a prompt can be generated from a template in which portions of “energizing lunch box shop”, “stamina bowl”, and “unpacking goods” are blank. In this case, the sentence generation unit 108 can generate a prompt by inputting, to the template, information of “suggested meal information” and “name of providing place” indicated in the suggested meal information 40 and “work” indicated in the employee related data 30. The user may also edit the prompt by using the input/output interface 2.

Upon receiving the input of the prompt, the sentence generation unit 108 generates a comment 80 for suggesting a meal to the employee using the language model. The sentence generation unit 108 transmits the generated comment 80 to the presentation unit 104. The sentence generation unit 108 may change the output of the language model based on conditions (the size of the display region, the number of characters, and the like) designated by the user. For example, the sentence generation unit 108 calculates the number of characters that fits within the display region based on the size of the display region, and generates the comment 80 equal to or less than the number of characters. For example, the sentence generation unit 108 can generate the comment 80 satisfying the restriction by using a prompt describing the restriction on the number of characters.

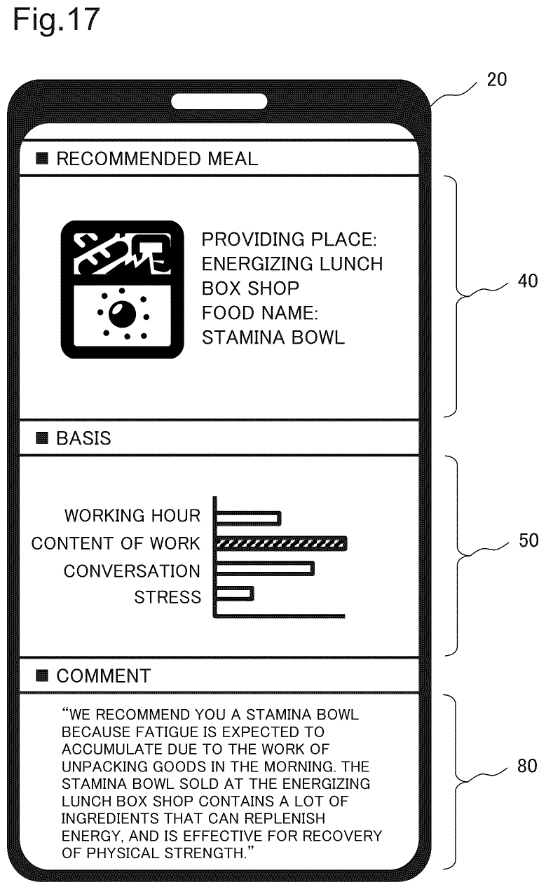

The presentation unit 104 of the third example embodiment is different from the presentation unit 104 of the first example embodiment in that the comment 80 in addition to the suggested meal information 40 and the basis information 50 are output. As illustrated in FIG. 17, the presentation unit 104 outputs the suggested meal information 40 determined by the meal suggestion unit 102, the basis information 50 generated by the basis information generation unit 103, and the comment 80 generated by the sentence generation unit 108 to the terminal device 20. These pieces of information are not necessarily displayed at the same time.

As described above, the meal suggestion device 100 according to the third example embodiment has a feature that does not exist in the meal suggestion devices 100 according to the first and second example embodiments, which is that a sentence is generated by using the suggested meal information 40, the basis information 50, and a language model. As a result, the meal suggestion device 100 of the third example embodiment can suggest a meal to the target employee 10 together with the comment 80 describing the basis and the content of the suggested meal after clarifying the reason for selection.

Even when the user looks at the suggested meal, it may be difficult for the user to understand why the meal is recommended and the meal is based on what criteria and calculation logic. Note that such a problem may also occur in a scene where a meal is suggested to a person other than the employee.

According to an aspect of the present disclosure, it is possible to suggest a meal to an employee after clarifying a reason for selection.

While the present disclosure has been particularly illustrated and described with reference to example embodiments thereof, the present disclosure is not limited to these example embodiments. Various modifications that can be understood by those of ordinary skill in the art can be made to the configuration and details of the present disclosure within the scope of the present disclosure. The present disclosure may include example embodiments in which the matters described in the present specification are appropriately combined or replaced as necessary. For example, the matters (including drawings) described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content. The processing of each step illustrated in each flowchart can be executed by one processor, or can be executed by a plurality of processors in a shared manner. That is, the execution subject of the meal suggestion method according to each of the above-described example embodiments may be one processor or a plurality of processors.

Further, it is noted that the inventor's intent is to retain all equivalents of the claimed disclosure even if the claims are amended during prosecution.

Some or all of the above example embodiments can also be described as the following Supplementary Notes. However, some or all of the above example embodiments are not limited to the following.

### (Supplementary Note 1)

A meal suggestion device including an acquisition unit that acquires target person related data related to a target person to whom a meal is to be suggested, a meal suggestion unit that determines a meal to be suggested to the target person using the target person related data, a basis information generation unit that generates basis information indicating a basis for suggesting the meal, and a presentation unit that presents the suggested meal and the basis information.

### (Supplementary Note 2)

The meal suggestion device according to Supplementary Note 1, further including an incentive information determination unit that determines incentive information indicating an incentive for the target person to select the meal to be suggested.

### (Supplementary Note 3)

The meal suggestion device according to Supplementary Note 1 or 2, wherein the meal suggestion unit determines a meal provided at a place within a predetermined range from position information of the target person as a meal to be suggested to the target person, and the presentation unit presents a map indicating position information of the target person and a place where the meal is provided.

### (Supplementary Note 4)

The meal suggestion device according to Supplementary Note 3, further including a route optimization unit that optimizes a route from a location of the target person to a place where the meal is provided using a constraint condition including at least part of the meal and the target person related data as a condition, and the presentation unit displays a route optimized by the route optimization unit on the map.

### (Supplementary Note 5)

A meal suggestion method including at least one processor acquiring target person related data related to a target person to whom a meal is to be suggested, determining a meal to be suggested to the target person using the target person related data, generating basis information indicating a basis for suggesting the meal, presenting the meal to be suggested, and presenting the basis information.

### (Supplementary Note 6)

A meal suggestion program for causing a computer to execute the steps of acquiring target person related data related to a target person to whom a meal is to be suggested, determining a meal to be suggested to the target person using the target person related data, generating basis information indicating a basis for suggesting the meal, presenting the meal to be suggested, and presenting the basis information.

The forms of Supplementary Note 5 and Supplementary Note 6 described above can be expanded to the forms of Supplementary Note 2 to Supplementary Note 4, as in Supplementary Note 1.

### REFERENCE SIGNS LIST

1 processor
2 input/output interface
3 ROM
4 RAM
5 storage device
6 bus
10 target employee
20 terminal device
30 employee related data
40 suggested meal information
50 basis information
60 incentive information
70 optimal route information
80 comment
100 meal suggestion device
101 acquisition unit
102 meal suggestion unit
103 basis information generation unit
104 presentation unit
105 incentive information determination unit
106 route optimization unit
107 instruction unit
108 sentence generation unit

1. A meal suggestion device comprising:
at least one memory configured to store instructions; and
at least one processor configured to execute the instructions to:
acquire target person related data related to a target person to whom a meal is to be suggested;
determine a suggested meal to be suggested to the target person using the target person related data;
generate basis information indicating a basis for suggesting the suggested meal; and
present the suggested meal and the basis information.

2. The meal suggestion device according to claim 1, wherein the at least one processor is further configured to execute the instructions to:
determine incentive information indicating an incentive for the target person to select the suggested meal.

3. The meal suggestion device according to claim 1, wherein the at least one processor is further configured to execute the instructions to:
determine a meal provided at a place within a predetermined range from position information of the target person as the suggested meal; and
present a map indicating position information of the target person and a place where the suggested meal is provided.

4. The meal suggestion device according to claim 3, wherein the at least one processor is further configured to execute the instructions to:
optimize a route from a location of the target person to the place where the suggested meal is provided using a constraint condition including at least part of the meal and the target person related data; and
display the route on the map.

5. The meal suggestion device according to claim 1, wherein the at least one processor is further configured to execute the instructions to:
determine the suggested meal by inputting the target person related data to a model that machine learned a relationship between the target person related data and a meal related to the target person related data.

6. A meal suggestion method comprising:
acquiring target person related data related to a target person to whom a meal is to be suggested;
determining a suggested meal to be suggested to the target person using the target person related data;
generating basis information indicating a basis for suggesting the suggested meal; and
presenting the suggested meal and the basis information.

7. The meal suggestion method according to claim 6, further comprising:
determining incentive information indicating an incentive for the target person to select the suggested meal.

8. The meal suggestion method according to claim 6, further comprising:
determining a meal provided at a place within a predetermined range from position information of the target person as the suggested meal; and
presenting a map indicating position information of the target person and a place where the suggested meal is provided.

9. The meal suggestion method according to claim 8, further comprising:
optimizing a route from a location of the target person to the place where the suggested meal is provided using a constraint condition including at least part of the meal and the target person related data; and
displaying the route on the map.

10. The meal suggestion method according to claim 6, further comprising:
determining the suggested meal by inputting the target person related data to a model that machine learned a relationship between the target person related data and a meal related to the target person related data.

11. A non-transitory computer-readable recording medium that records a program for causing a computer to execute:
acquiring target person related data related to a target person to whom a meal is to be suggested;
determining a suggested meal to be suggested to the target person using the target person related data;
generating basis information indicating a basis for suggesting the suggested meal; and
presenting the suggested meal and the basis information.

12. The recording medium, according to claim 11, that records the program for causing the computer to further execute:
determining incentive information indicating an incentive for the target person to select the suggested meal.

13. The recording medium, according to claim 11, that records the program for causing the computer to further execute:
determining a meal provided at a place within a predetermined range from position information of the target person as the suggested meal; and
presenting a map indicating position information of the target person and a place where the suggested meal is provided.

14. The recording medium, according to claim 13, that records the program for causing the computer to further execute:
optimizing a route from a location of the target person to the place where the suggested meal is provided using a constraint condition including at least part of the meal and the target person related data; and
displaying the route on the map.

15. The recording medium, according to claim 11, that records the program for causing the computer to further execute:
determining the suggested meal by inputting the target person related data to a model that machine learned a relationship between the target person related data and a meal related to the target person related data.
